(19) United States
(12) Patent Application Publication
(10) Pub. No.: US 2007/0081109 A1
(43) Pub. Date: Apr. 12, 2007

(54) Display with recording/reproducing device

(75) Inventor: Yoshihiro Igarashi, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/544,623

(22) Filed: Oct. 10, 2006

(30) Foreign Application Priority Data
Oct. 11, 2005 (JP) 2005-296158

(51) Int. Cl. G02F 1/1333

(52) U.S. Cl. 349/58

(57) ABSTRACT

Disclosed is a display with a recording/reproducing device that has a chassis supporting a disk drive. The chassis is provided with a through hole in a part thereof corresponding to the disk drive. A box holding component parts therein is formed by assembling a front case and a back case. The back case has a bottom wall provided with inlet through holes and a top wall provided with outlet through holes to form an air passage extending from the inlet through holes through the interior of the body to the outlet through holes. The disk drive is disposed in the air passage. Air flows by convection through the air passage to cool the disk drive effectively.

The present application is based on and claims priority of Japanese patent application No. 2005-296158 filed on Oct. 11, 2005, the entire contents which are hereby incorporated by reference.

### BACKGROUND OF THE INVENTION

1. Field of the Invention

The present invention relates to a display with a recording/reproducing device and, more particularly, to a display with a recording/reproducing device having an improved heat radiating mechanism.

2. Description of the Related Art

The thickness and size of displays, such as liquid crystal displays and plasma displays, have been progressively reduced relative to their screen size. A compact display having a small thickness and an overall size has component parts including heat-generative parts arranged in a high density therein and hence troubles attributable to heat are likely to occur in the compact display. Therefore, heat-dissipating measures need to be taken in designing a display with a built-in recording/reproducing device, such as a DVD drive.

Techniques relevant to a heat dissipating mechanism for a plasma display, namely, a display, are disclosed in Japanese Patent Laid-Open Publication No. 11-284379 (Patent Document 1). Techniques relevant to heat dissipating mechanism for an optical disk drive, namely, recording/reproducing device, are disclosed in Japanese Patent Laid-Open Publication No. 2005-166218 (Patent Document 2).

A representative heat dissipating mechanism for an electronic device includes a cooling fan. This heat dissipating mechanism increases the number of parts and the cost of the electronic device, requires additional assembling work, generates noise and increases power consumption. The cooling fan simply stirs hot air and cannot efficiently work for cooling unless a circulation passage including an intake air passage for taking in cool air and a discharge air passage for discharging hot air is formed properly.

### SUMMARY OF THE INVENTION

The present invention has been made in view of those problems and it is therefore an object of the present invention to provide a display with a recording/reproducing device having a low-cost heat radiating mechanism capable of efficiently cooling the recording/reproducing device.

A display with a recording/reproducing device according to one aspect of the present invention includes: a recording/reproducing device capable of recording information on or reading information from a recording medium or capable of recording information on and reading information from a recording medium; a display panel; a chassis supporting the recording/reproducing device; and a body holding those component parts therein; wherein the chassis is provided with an opening in a part thereof corresponding to the recording/reproducing device.

Since the opening is formed in the part of the chassis supporting the recording/reproducing device nearest to the recording/reproducing device, air can be easily circulated by convection through the opening.

In the display with a recording/reproducing device according to the aspect of the present invention, the body may have a top wall provided with a plurality of outlet openings through which hot air is discharged for heat dissipation, and a bottom wall provided with a plurality of inlet openings through which external air flows into the body to define an air passage through which air flows from a space extending outside the bottom wall to a space extending outside the top wall.

When the air passage extends from the space extending outside the bottom wall through the body to the space extending outside the top wall, external air can easily flow from the exterior of the display through the display to the exterior of the display by convection.

In the display with a recording/reproducing device according to the aspect of the present invention, the recording/reproducing device may be disposed in the air passage extending from the space extending outside the bottom wall through the body to the space extending outside the top wall.

The recording/reproducing device is disposed in the air passage.

In the display with a recording/reproducing device according to the aspect of the present invention, the chassis may be extended vertically in the body, the vertical length of the opening or the vertical length of a perforated part provided with a plurality of openings may be longer than the vertical length of the recording/reproducing device supported on the chassis, and the air passage may extend from the inlet openings through the opening or the perforated part to the outlet openings.

Since the air passage extends from the outside of the bottom wall of the body through the opening or the perforated part to the outside of the top wall of the body, air can easily flow between the exterior of the body and the space around the recording/reproducing device by convection.

In the display with a recording/reproducing device according to the aspect of the present invention, the body may be formed by assembling a front case and a back case, the display panel may be held on the front surface of the chassis, the chassis may be attached to the front case, the recording/reproducing device may be attached to the back surface of the chassis, the display panel, the chassis and the recording/reproducing device may be held in the body, and the outlet openings and the inlet openings may be formed in the top and the bottom wall of the back case, respectively.

### BRIEF DESCRIPTION OF THE DRAWINGS

The above and other objects, features and advantages of the present invention will become more apparent from the following description taken in connection with the accompanying drawings, in which:

FIG. 1 is a schematic perspective view of a liquid crystal television set with a built-in DVD drive in a preferred embodiment according to the present invention;

FIG. 2 is a rear view of the liquid crystal television set shown in FIG. 1, in which a back case is removed;

FIG. 3 is a rear view, similar to FIG. 2, of the liquid crystal television set shown in FIG. 1, in which a DVD drive is removed;

FIGS. 4(a), 4(b) and 4(c) are a top view, a rear view and a bottom view, respectively, of the back case;

FIG. 5 is a sectional view taken on the line A-A in FIG. 2;

FIG. 6 is a front elevation of a disk drive; and

FIG. 7 is the liquid crystal television set provided with a chassis having a part provided with through holes, in which the back case is removed.

### DESCRIPTION OF THE PREFERRED EMBODIMENTS

Hereinafter, specific examples of the present invention will be explained with reference to the attached drawings, obviously many changes and variations are possible therein. It is therefore to be understood that the present invention be practiced otherwise than as specifically described herein without departing from the scope and spirit thereof.

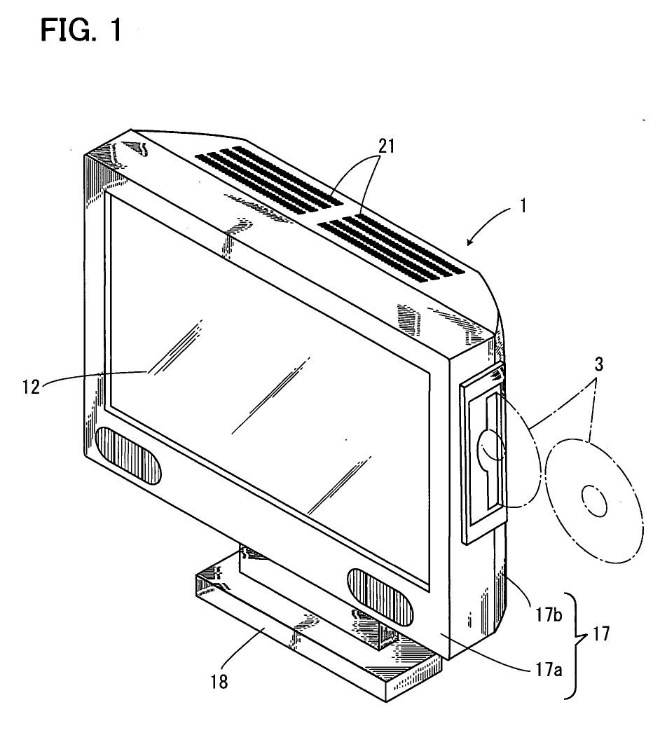

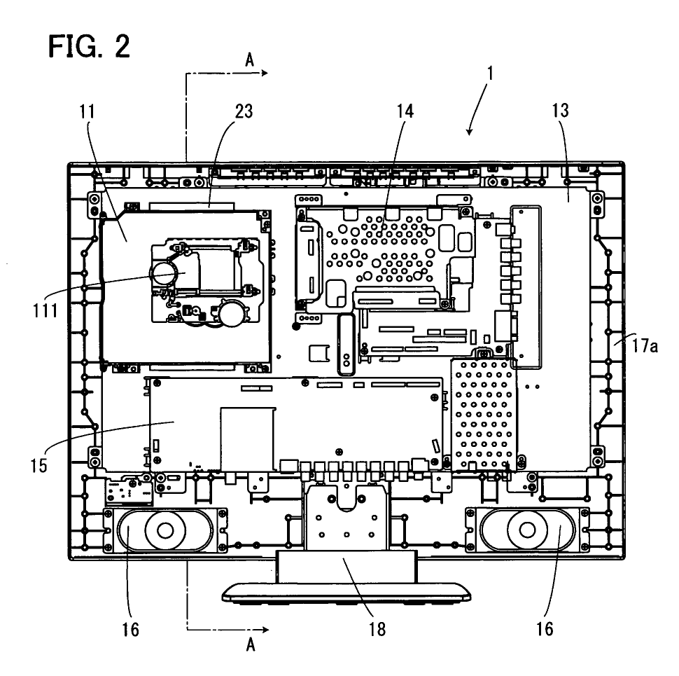

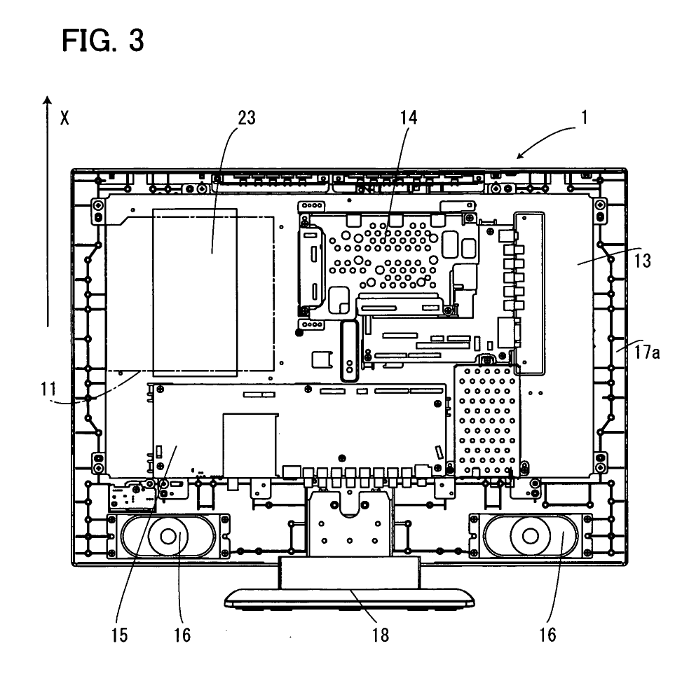

FIG. 1 is a schematic perspective view of a liquid crystal television set 1 with a built-in DVD drive (hereinafter, referred to as “LCD 1 with a DVD drive”) in a preferred embodiment according to the present invention, FIG. 2 is a rear view of the LCD 1 with a DVD drive shown in FIG. 1, in which a back case is removed, and FIG. 3 is a rear view, similar to FIG. 2, of the LCD 1 with a DVD drive, in which a disk drive is removed.

The LCD 1 with a built-in DVD drive in this embodiment includes a disk drive 11, namely, a recording/reproducing device, for reading information from a DVD, namely, information recording medium, a LCD module 12, namely, a display panel, a chassis 13, a disk drive control circuit wiring board 14 provided with control circuits for controlling the disk drive 11 and processing signals provided by the disk drive 11, a main control circuit wiring board 15 provided with a main control circuit, loudspeakers 16, a body 17 holding the foregoing component parts and formed by assembling a front case 17a and a back case 17b, and a stand 18 attached to the chassis 13.

The LCD module 12 is attached to the front surface of the chassis 13, and the chassis 13 is attached to the front case 17a. The disk drive 11, the disk drive control circuit wiring board 14 and the main control circuit wiring board 15 are attached to the back surface of the chassis 13. The loudspeakers 16 are attached to the front case 17a. Then, the back case 17b is joined to the front case 17a to contain those component parts in the body 17.

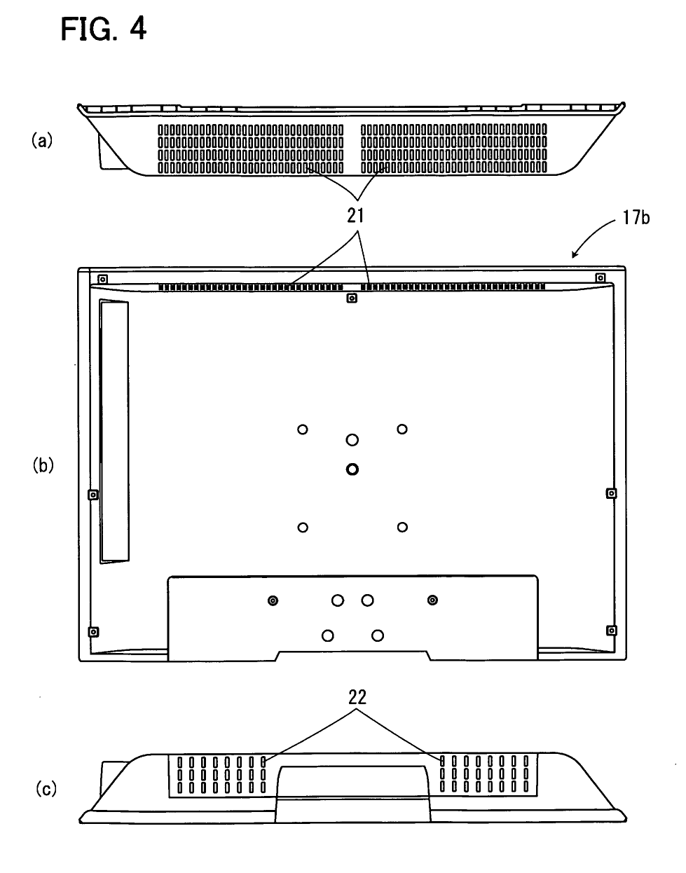

FIGS. 4(a), 4(b) and 4(c) are a top view, a rear view and a bottom view, respectively, of the back case 17b. Referring to FIG. 4, the back case 17b has a top wall provided with a plurality of outlet through holes 21, namely, exhaust holes 21, and a bottom wall provided with a plurality of inlet through holes 22, namely, intake holes 22. As shown in FIGS. 2 and 3, a through hole 23 is formed in a part of the chassis 13 corresponding to the disk drive 11. The through hole 23 has a length, namely, a vertical dimension along the direction of the arrow X in FIG. 3, greater than the length, namely, a vertical dimension along the direction of the arrow X, of the disk drive 11 supported on the chassis 13. As shown in FIG. 2, the through hole 23 has an upper part and a lower part extending beyond the upper and the lower edge, respectively, of the disk drive 11. Parts of the back case 17b in which the outlet through holes 21 and the inlet through holes 22 are formed, the disk drive 11 attached to the chassis 13, and the through hole 23 formed in the chassis 13 are contained in a vertical position extending along the direction of the arrow X.

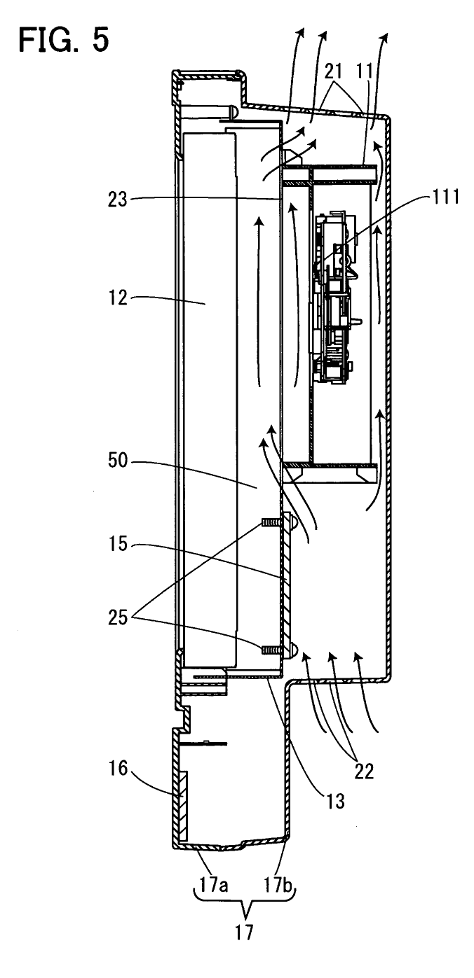

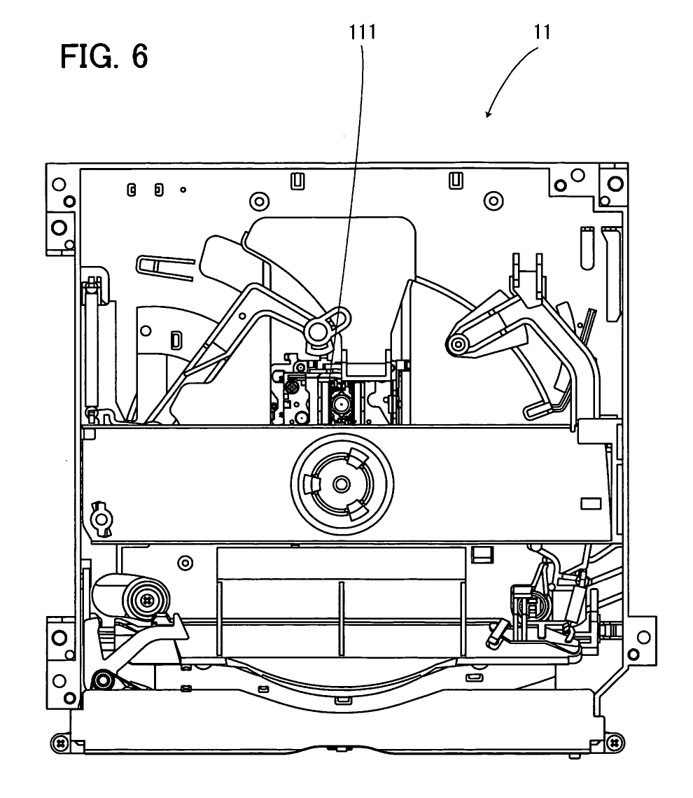

Thus an air passage extending from the inlet through holes 22 through the through hole 23 to the outlet through holes 21 is formed in the LCD 1 with a built-in DVD drive. As shown in FIG. 5 in a sectional view taken on the line A-A in FIG. 2, the disk drive 11 is in the air passage represented by arrows in FIG. 5. FIG. 6 is a front elevation showing the front surface of the disk drive 11 facing the chassis 13. The disk drive 11 is provided with a pickup unit 111 exposed to both the air passage on the side of the chassis 13 as shown in FIG. 6 and a space extending in front of the back case 17b as shown in FIG. 2. When the disk drive 11 is supported on the chassis 13 as shown in FIG. 5, the disk drive is placed in the air passage. Thus the disk drive 11 can be effectively cooled by air flowing along the air passage by convection. The LCD module 12 is spaced by a space 50 from the chassis 13 such that the tips of screws 25 screwed into threaded holes formed in the chassis 13 from behind the chassis 13 to fasten the disk drive 11, the disk drive control circuit wiring board 14 and the main control circuit wiring board 15 to the chassis 13 do not touch the LCD module 12. The space 50 is part of the air passage for efficient convection. Since the chassis 13 in this embodiment is designed to support any one of a plurality of types of LCD modules, the space 50 is comparatively large.

The LCD 1 with a built-in DVD drive has the chassis 13 supporting the disk drive 11 and is provided with the through hole 23 in a part thereof corresponding to the disk drive 11. The through hole 23 facilitate air flow by convection around the disk drive 11 and the disk drive 11 can be effectively cooled. The air passage extending from the inlet through holes 22 formed in the bottom wall of the back case 17b through the body 17 to the outlet through holes 21 formed in the top wall of the back case 17b facilitates air circulation through the space containing the disk drive 11 by convection. Thus the disk drive 11 can be efficiently cooled. Since the LCD 1 with a built-in DVD drive does not need any additional cooling device, such as a cooling fan, increase in the cost resulting from increase in the number of parts and assembling work, noise generation and increase in power consumption can be avoided. If the LCD 1 with a DVD drive is provided with a cooling fan, the air passage will enhance the cooling effect of the cooling fan.

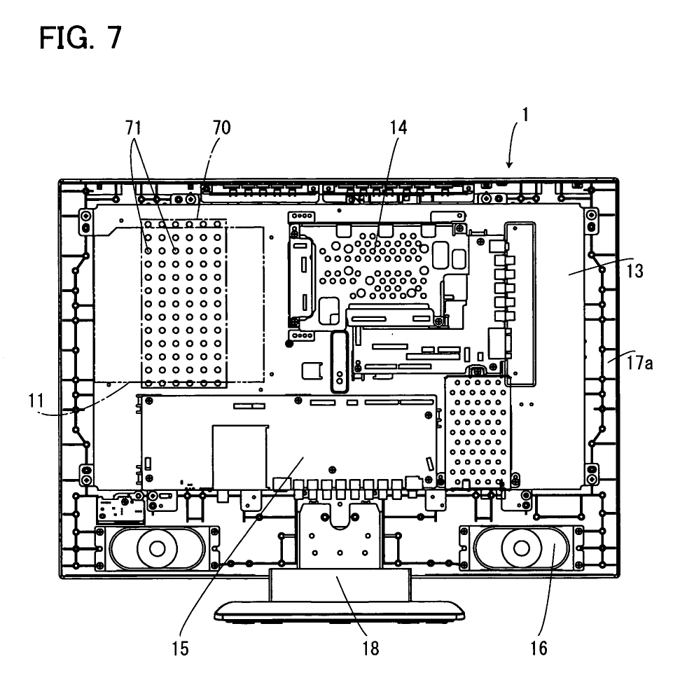

The chassis 13 in this embodiment is provided with the rectangular through hole 23 as shown in FIG. 3. The chassis 13 maybe provided with a perforated part 70 provided with a plurality of through holes 71 as shown in FIG. 7 instead of the rectangular through hole 23. Through holes may be formed in the upper and lower member of a frame included in the disk drive 11 to reduce resistance against the flow of air flowing from the inlet through holes 22 toward the outlet through holes 21. Those through holes formed in the upper and the lower member of the frame facilitate convection to enhance cooling effect.

Although the invention has been described as applied to the LCD, the present invention is not limited thereto in its practical application. The present invention is effectively applicable to, for example, plasma displays and organic EL displays. Although the LCD provided with the disk drive, such as a DVD drive, has been described, the present invention is effectively applicable to recording/reproducing devices subject to troubles due to heat, such as recording/reproducing devices for recording signals on and/or reproducing signals from optical disks, HDs and semiconductor storage devices.

The effects of the present invention are as follows.

Since the through hole is formed in the part, corresponding to the recording/reproducing device, of the chassis, air can be easily circulated by convection through the through hole and the recording/reproducing device can be effectively cooled.

The air passage is extended from the space extending outside the bottom wall through the body to the space extending outside the top wall, air can easily flow from the exterior of the display through the display to the exterior of the display by convection and hence the interior of the display can be effectively cooled. Therefore, any additional cooling device, such as a cooling fan, is not necessary, increase in the cost of the display resulting from increase in the number of parts and assembling work, noise generation and increase in power consumption can be avoided. If the display is provided with a cooling fan, the air passage will enhance the cooling effect of the cooling fan.

The recording/reproducing device disposed in the air passage can be efficiently cooled.

The air passage extends from the outside of the bottom wall of the body through the through hole to the outside of the top wall of the body, air can easily flow between the exterior of the body and the space around the recording/reproducing device by convection and the recording/reproducing device can be effectively cooled.

What is claimed is:

1. A display with a recording/reproducing device, comprising:
a recording/reproducing device capable of recording information on or reading information from a recording medium or capable of recording information on and reading information from a recording medium;
a display panel;
a chassis supporting the recording/reproducing device; and
a body holding those component parts therein;
wherein the chassis is provided with an opening in a part thereof corresponding to the recording/reproducing device.

2. The display with a recording/reproducing device according to claim 1, wherein the body has a top wall provided with a plurality of outlet openings through which hot air is discharged for heat dissipation, and a bottom wall provided with a plurality of inlet openings through which external air flows into the body to define an air passage through which air flows from a space extending outside the bottom wall to a space extending outside the top wall.

3. The display with a recording/reproducing device according to claim 2, wherein the recording/reproducing device is disposed in the air passage extending from the space extending outside the bottom wall through the body to the space extending outside the top wall.

4. The display with a recording/reproducing device according to claim 2, wherein the chassis is extended vertically in the body, the vertical length of the opening or the vertical length of a perforated part provided with a plurality of openings is longer than the vertical length of the recording/reproducing device supported on the chassis, and the air passage extends from the inlet openings through the opening or the perforated part to the outlet openings.

5. The display with a recording/reproducing device according to claim 2, wherein the body formed by assembling a front case and a back case, the display panel is held on the front surface of the chassis, the chassis is attached to the front case, the recording/reproducing device is attached to the back surface of the chassis, the display panel, the chassis and the recording/reproducing device are held in the body, and the outlet openings and the inlet openings are formed in the top and the bottom wall of the back case, respectively.

6. The display with a recording/reproducing device according to claim 3, wherein the chassis is extended vertically in the body, the vertical length of the opening or the vertical length of a perforated part provided with a plurality of openings is longer than the vertical length of the recording/reproducing device supported on the chassis, and the air passage extends from the inlet openings through the opening or the perforated part to the outlet openings.

7. The display with a recording/reproducing device according to claim 3, wherein the body formed by assembling a front case and a back case, the display panel is held on the front surface of the chassis, the chassis is attached to the front case, the recording/reproducing device is attached to the back surface of the chassis, the display panel, the chassis and the recording/reproducing device are held in the body, and the outlet openings and the inlet openings are formed in the top and the bottom wall of the back case, respectively.

8. The display with a recording/reproducing device according to claim 4, wherein the body formed by assembling a front case and a back case, the display panel is held on the front surface of the chassis, the chassis is attached to the front case, the recording/reproducing device is attached to the back surface of the chassis, the display panel, the chassis and the recording/reproducing device are held in the body, and the outlet openings and the inlet openings are formed in the top and the bottom wall of the back case, respectively.

9. The display with a recording/reproducing device according to claim 5, wherein the body formed by assembling a front case and a back case, the display panel is held on the front surface of the chassis, the chassis is attached to the front case, the recording/reproducing device is attached to the back surface of the chassis, the display panel, the chassis and the recording/reproducing device are held in the body, and the outlet openings and the inlet openings are formed in the top and the bottom wall of the back case, respectively.
